(19) United States
(12) Patent Application Publication
(10) Pub. No.: US 2001/0032127 A1
(43) Pub. Date: Oct. 18, 2001

(54) Mobile display system and method

(76) Inventor: Lennox Lewis, Old Bridge, NJ (US)

Correspondence Address: MATHEWS, COLLINS, SHEPHERD & GOULD, PA, 100 THANET CR, SUITE 306, PRINCETON, NJ, 08540, US

(21) Appl. No.: 09/747,644

(22) Filed: Dec. 22, 2000

Related U.S. Application Data
(60) Provisional application No. 60/171,869, filed on Dec. 23, 1999.

(51) Int. Cl. G06F 17/60

(52) U.S. Cl. 705/14; 348/61; 348/739

(57) ABSTRACT

A method for enabling the targeted presentation of a multimedia experience in locations typically limited to the traditional print media to a potential viewer of multimedia advertising comprising accessing a selection of multimedia advertisements; accessing a selection of additional content; choosing a subset from the selection of multimedia advertisements; choosing a subset from the selection of additional content; and, presenting the subset from the selection of multimedia advertisements and the subset from the selection of additional content on a multimedia display.

### CROSS REFERENCES TO RELATED APPLICATIONS

This application claims the benefit of U.S. Provisional application Ser. No. 60/171,869 filed on Dec.23, 1999.

### FIELD OF THE INVENTION

This invention relates to a business method and more particularly to a business method for presentation of multimedia advertising.

### BACKGROUND OF THE INVENTION

Advertising displayed today in public settings typically consists of still images displayed on posters, billboards, and murals. In a limited number of applications, animation and three-dimensional objects, and creative lighting have been added to enhance the static information. Printed media has been the primary source of communicating information, including news and advertising, for centuries. The commercialization of the Internet has expanded the concept of printed media into an electronically readable form introducing interactive multi-media capabilities unparalleled by traditional printed media. Unfortunately, there are many situations in which typical users even those who may possess the necessary technical expertise to efficiently use the Internet as an efficient source of information are able to utilize the technology because of physical and time constraints.

Therefore there is a need for a system, which can present to typical users of printed media the “virtual print” of a multimedia experience unavailable in traditional printed media.

### SUMMARY OF THE INVENTION

In one aspect, the present invention features a business model, which will enable the presentation of a multimedia experience in locations typically limited to the traditional print media.

### BRIEF DESCRIPTION OF THE DRAWINGS

A more complete understanding of the present invention may be obtained from consideration of the following description in conjunction with the drawings in which:

FIG. 1 is a stylized overview of interconnected computer system networks, and FIG. 2 is a stylized overview of mobile display system.

### DETAILED DESCRIPTION OF VARIOUS ILLUSTRATIVE EMBODIMENTS

Although the present invention is particularly well suited for use in connecting through the Internet and shall be so described, the present invention is equally well suited for use in other network communication systems such as an Intranet, Interactive television (iTV) and similar interactive communication systems.

The Internet is a worldwide system of computer networks—a network of networks in which users at one computer can obtain information from any other computer (and communicate with users of the other computers). The Internet was conceived by the Advanced Research Projects Agency (ARPA) of the U.S. government in 1969 and was first known as the ARPANet. The original aim was to create a network that would allow users of a research computer at one university to be able to communicate with research computers at other universities. A key design element of ARPANet that, because messages could be routed or rerouted in more than one direction during the course of a communication link, the network could continue to function even if parts of it were destroyed such as by a military attack or natural disaster.

The Internet has evolved into a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called Transmission Control Protocol/Internet Protocol (TCP/IP).

For many Internet users, electronic mail (e-mail) has essentially all but replaced the Postal Service for short written transactions. E-mail is the most widely used application on the Internet. Live “conversations” can be carried on with other computer users, using Internet Relay Chat (IRC). More recently, Internet telephony hardware and software allows real-time voice conversations.

The most widely used part of the Internet is the World Wide Web (often abbreviated “WWW” or called “the Web”). The most outstanding feature of the Web is its use of hypertext, which is a method of instant cross-referencing. In most Web sites, certain words or phrases appear in text of a different color than the rest; often this text is also underlined. When one of these words or phrases is selected, it's a hyperlink, transferring the user to the site or page that is relevant to this word or phrase. Sometimes there are buttons, images, or portions of images that are “clickable.” Using the Web provides access to millions of pages of information. Web “surfing” is done with a Web browser; the most popular of which presently are Netscape Navigator and Microsoft Internet Explorer. The appearance of a particular Web site may vary slightly depending on the particular browser used. Recent versions of browsers have plug-ins, which provide animation, virtual reality, sound, and music.

Because the Internet evolved from the ARPAnet, a research experiment that supported the exchange of data between government contractors and (often academic) researchers, an on-line culture developed that is alien to the corporate business world. Although the Internet was not designed to make commercialization easy, commercial Internet publishing and various forms of e-commerce have rapidly evolved. In part it is the very ease that anyone can publish a document that is accessible by a large number of people that makes electronic publishing attractive. Setting up e-commerce provides low overhead while reaching a worldwide market 24 hours a day. The growth and popularity of the Internet is providing new opportunities for commercialization including but not limited to Web sites driven by electronic commerce, ad revenue, branding, database transactions, and intranet/extranet applications.

Domain names direct where e-mail is sent, files are found, and computer resources are located. They are used when accessing information on the Web or connecting to other computers through Telnet. Internet users enter the domain name, which is automatically converted to the Internet Protocol address by the Domain Name System (DNS).

E-mail was one of the first services developed on the Internet. Today, e-mail is an important service on any computer network, not just the Internet. E-mail involves sending a message from one computer account to another computer account. E-mail is used to send textual information as well as files, including graphic files, executable files, word processing and other files. E-mail is becoming a popular way to conduct business over long distances. Using e-mail to contact a business associate can be faster than using a voice telephone, because the recipient can read it at a convenient time, and the sender can include as much information as needed to explain the situation.

On-line commerce, or “e-commerce”, uses the Internet, of which the Web is a part, to transfer large amounts of information about numerous goods and services in exchange for payment or customer data needed to facilitate payment. Potential customers can supply a company with shipping and invoicing information without having to tie up sales staff. The convenience offered to the customer is that they don't have to drive around town all day looking for the product they want.

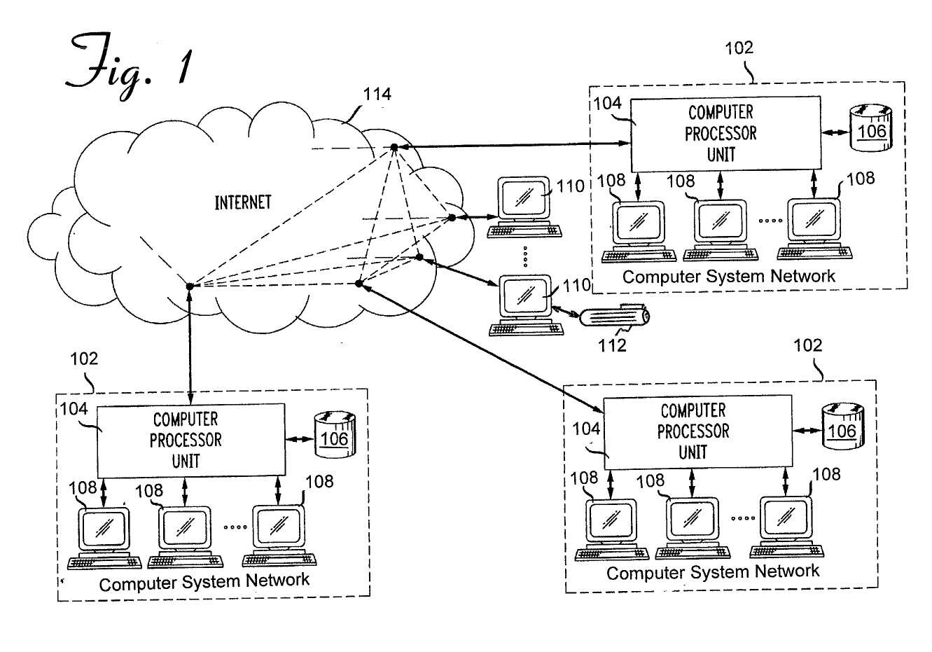

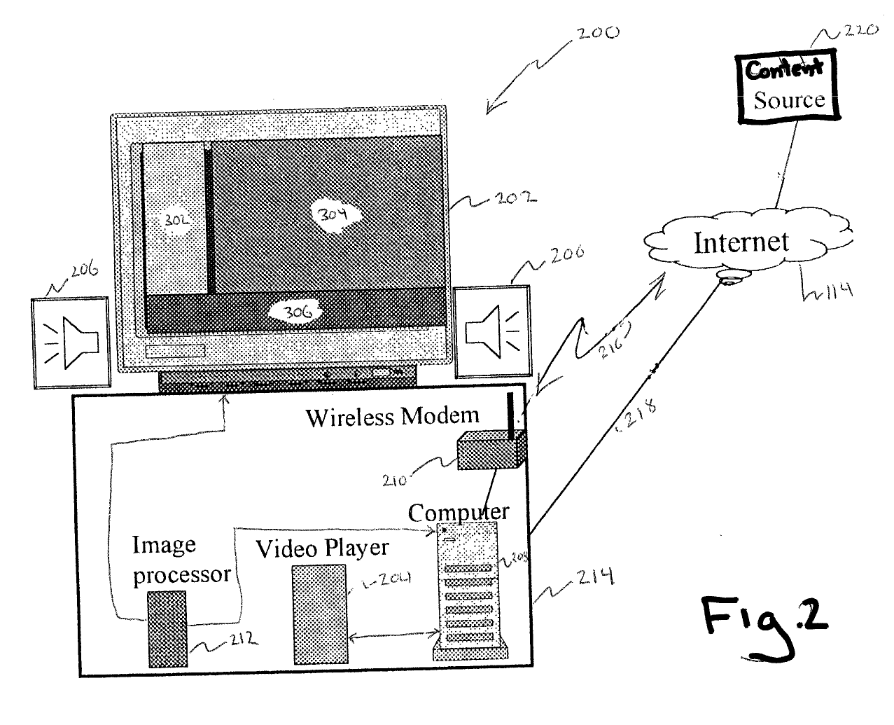

Referring to FIG. 1 there is shown a stylized overview of interconnected computer system networks. Each computer system network 102 contains a corresponding local computer processor unit 104, which are coupled to a corresponding local data storage unit 106, and local network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the Web page. The Web page may contain links to other computer systems and other Web pages.

While advertising displayed today in public settings typically consists of still images displayed on posters, billboards, and murals, the commercialization of the Internet has expanded the concept of printed media into an electronically readable form introducing interactive multi-media capabilities unparalleled by traditional printed media. Unfortunately, there are many situations in which typical users even those who may possess the necessary technical expertise to efficiently use the Internet as an efficient source of information are able to utilize the technology because of physical and time constraints.

The present invention, mobile display system, is a system, which presents to typical users of printed media the “virtual print” of a multimedia experience unavailable in traditional printed media. The present invention, mobile display system, functions as a standalone mobile multimedia unit capable of being deployed in a public location, and without the need for either audio or video feed from a television station.

The present invention, mobile display system, delivers true multimedia content and advertising to the general public. The mobile display system provides an extremely flexible way to handle a substantial variety of advertisements from simple text to full range motion videos. In addition to advertising, the present invention, mobile display system is designed to attract attention to itself by displaying additional multimedia content. The additional content includes information and data of interest such as real time stock quotes, local time, weather, news, and sports updates. This content would be downloaded to the mobile display system. The content is tailored or filtered to reflect the locale in which the unit is placed, as well as to take advantage of the particular time and coordinate with surrounding events. For example, a mobile display system deployed in Newark, N.J., would display weather related datum, such as the temperature, that is specific to Newark, and provide information on road, train and airport conditions. When a local concert is starting at a performing art center, advertising content can be directed to restaurants for a late dinner. Seasonal and holiday information may be targeted at commuters on the way home. The advertising may include contact information such as telephone numbers and/or web addresses, which can easily be accessed from a wireless communication link, such as a wireless telephone or personal digital assistant with a wireless interface.

The mobile display system is an advertisement medium and information center. The mobile display system is configured and may be dynamically reconfigured to display content and advertisement in public areas such as malls, airports, bus and train stations, and other secure public buildings. The information and advertisement can include audio, video, data text, and images.

Security of the mobile display system location is related rather to the useful life of a particular mobile display system. Such security is intended to connote protection from weather elements such as rain, snow, extreme heat and reasonable protection from vandalism.

Although the mobile display system is targeted to present advertisements, additional content, including real time stock quotes, news, sports and weather textual data, may be retrieved from designated sources and displayed. In one embodiment of the present invention, the additional content is retrieved via the Internet. The additional value-added informational content is intended to attract or pull-in people to view the advertisements displayed by the mobile display system. The additional content would comprise current information—continuously being updated—rather than being stale information. The combination of simultaneously displaying added content and advertisements will provide a particularly effective stimuli in grabbing the public's attention.

The ubiquitous reach of the Internet is leveraged to deliver this innovative advertising and information services. Connectivity via the Internet to content providers of stock updates, weather data, etc. from which the data is retrieved and displayed ensures current content. The mobile display system can be accessed via the internet from a central location for remote interrogation and management of the mobile display system regardless of where it is located. Through use of high speed Internet connections from such a central location, a variety of remote tasks may be implemented at an operating mobile display system, including: software upgrades; download of new advertising video/audio clips; reconfiguration of the display and form of the presentation; and, video feed from camera mounted on the display unit to provide live shots of the environment—e.g. for display at a Web site, from any location where a mobile display system unit is deployed.

Referring to FIG. 2 there is seen a stylized overview of the mobile display system. The mobile display system 200 comprises: at least one display unit 202; a video player 204; an audio system 206; a computer system 208; a communication link 210, such as a wireless modem, an image processor 212; and a mounting platform 214.

The display unit 202 is a system capable of displaying video. This may include a television monitor, projection system, CRT display or a plasma monitor (both analog and digital systems). The display unit 202, in one embodiment is divided into a minimum of three logical partitions 302, 304 and 306. Exemplary content for each of the three partitions is described. Logical partition 302 of the display unit 202 displays the local time and weather, sports, and other data. This partition will support vertical scrolling text, as necessary, to display information that cannot be entirely displayed. Logical partition 304 of the display unit 202, which is typically the largest partition, displays the primary advertisements. Logical partition 306 of the display unit 202 displays horizontal scrolling of real time stock quotes and news feed as obtained from designated sources via the Internet. The actual number of logical partitions and their size may be dynamically defined and reconfigured to better match the target audience.

The video player 204 can be any system capable of playing video. This includes VCR, DVD player, Disc Player, Digital video player, streaming digital video, compressed video sources, etc. The audio system 206 consists of one or more speakers with a suitable amplifier.

The computer 208 has sufficient hardware and software resources, including an IP address suitable communication means for making and establishing a connection over the Internet by a wireless interface 216 or a wired interface 218. The computer 208 operates to retrieve and process information over the Internet 114 from one or more content sources 220. Additionally, the computer 208 interfaces with an optional central command location. The content source 220 accessed over the Internet provides access to the relevant content such as real time stock quotes, news, weather and sports. Internet connectivity can be provided by dial-up modem, wireless modem 210, cellular modem, or dedicated wired/cable connection as well as by a cable modem.

The image processor 212 combines multiple video and PC content sources and input the combination into the display unit.

The mounting platform 214 is used to mount the display unit and house the system components. Essentially any mounting platform providing visual access to the display unit 202 may be used. Among the mounting platforms 214 that are suitable for use include a cart, a table, kiosk, wall or any structure providing sufficient support for the display unit 202.

The advertising content displayed in logical partition 304 and the added content displayed in logical partitions 302 and 306 are specifically targeted at a potential viewer. By considering the location, time of day, date, weather, calendar (holidays), the content is refined to appeal to the more likely potential viewer.

In yet a further embodiment of the present invention, the content is selective in response to external events, which a potential viewer may have just attended or be going to attend. Restaurant advertisements targeted for an afternoon theatre performance, vacations in warm locals for those caught in a snow storm, sporting survivors for those attending a sporting event, are but a small number of the large number of external events which can be used to selectively target the content. Sensing of a cell phone can even target a particular potential viewer, presenting a very startling result.

In view of the foregoing description, numerous modifications and alternative embodiments of the invention will be apparent to those skilled in the art. The mobile display system can be responsive to a cell phone or calling of a telephone number. Products having RFID tags can be sensed and used as a trigger. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

We claim:

1. A method for targeting presentation to a potential viewer of multimedia advertising comprising the following steps:
accessing a selection of multimedia advertisements;
accessing a selection of additional content;
choosing a subset from the selection of multimedia advertisements;
choosing a subset from the selection of additional content; and,
presenting the subset from the selection of multimedia advertisements and the subset from the selection of additional content on a multimedia display.

2. The method as recited in claim 1 wherein the step of choosing a subset from the selection of multimedia advertisements is a function of location.

3. The method as recited in claim 1 wherein the step of choosing a subset from the selection of additional content is a function of location.

4. The method as recited in claim 1 wherein the selection of additional content is a function of the subset of multimedia advertisements.

5. The method as recited in claim 4 wherein the step of choosing a subset from the selection of multimedia advertisements is a function of an external event.

6. The method as recited in claim 5 wherein the external event is a scheduled event.

7. The method as recited in claim 5 wherein the external event is a stimulus created by the potential viewer.

8. The method as recited in claim 1 wherein the step of choosing a subset from the selection of multimedia advertisements is a function of date and time.

9. The method as recited in claim 1 wherein the step of choosing a subset from the selection of additional content is a function of date and time.

10. A system for targeting presentation to a potential viewer of multimedia advertising comprising:
a display having a series of logical partitions;
a computer coupled to the display;
a video storage device coupled to the computer and the display;
a communication device coupled to the computer;
wherein the computer accesses a selection of multimedia advertisements and accesses a selection of additional content, chooses a subset from the selection of multimedia advertisements and chooses a subset from the selection of additional content and presents the subset from the selection of multimedia advertisements and the subset from the selection of additional content on the display in the series of logical partitions.

11. The system as recited in claim 10 wherein choosing a subset from the selection of multimedia advertisements is a function of location.

12. The system as recited in claim 10 wherein choosing a subset from the selection of additional content is a function of location.

13. The system as recited in claim 10 wherein the selection of additional content is a function of the subset of multimedia advertisements.

14. The system as recited in claim 13 wherein choosing a subset from the selection of multimedia advertisements is a function of an external event.

15. The system as recited in claim 14 wherein the external event is a scheduled event.

16. The system as recited in claim 14 wherein the external event is a stimulus created by the potential viewer.

17. The system as recited in claim 10 wherein choosing a subset from the selection of multimedia advertisements is a function of date and time.

18. The system as recited in claim 10 wherein choosing a subset from the selection of additional content is a function of date and time.

19. A system for targeting presentation to a potential viewer of multimedia advertising comprising:
a multimedia display having a series of logical partitions;
a computer coupled to the display;
a video storage device coupled to the computer and the display;
a communication device coupled to the computer;
wherein the computer accesses a selection of multimedia advertisements and accesses a selection of additional content, chooses a subset from the selection of multimedia advertisements and chooses a subset from the selection of additional content and presents the subset from the selection of multimedia advertisements and the subset from the selection of additional content on the display in the series of logical partitions, choosing a subset from the selection of multimedia advertisements is a function of location, time and date, choosing a subset from the selection of additional content is a function of location, time and date.

20. The system as recited in claim 19 wherein choosing a subset from the selection of multimedia advertisements is a function of an external event.
